(19) United States
(12) Patent Application Publication
(10) Pub. No.: US 2008/0189471 A1
(43) Pub. Date: Aug. 7, 2008

(54) ADHOC COMMUNICATIONS

(75) Inventors: ACHIM LUFT, Braunschweig (DE); Andreas Schmidt, Braunschweig (DE); Norbert Schwagmann, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 12/021,964

(22) Filed: Jan. 29, 2008

Related U.S. Application Data
(60) Provisional application No. 60/887,027, filed on Jan. 29, 2007.

(30) Foreign Application Priority Data
Jan. 29, 2007 (DE) 10 2007 004 386.6

(51) Int. Cl. G06F 12/00

(52) U.S. Cl. 711/100; 711/E12.001

(57) ABSTRACT

Embodiments relate to an adhoc communications network, an adhoc communications network memory administration unit, an adhoc communications device, a method for operating an adhoc communications network and a method for operating an adhoc communications device.

### TECHNICAL FIELD

Embodiments relate generally to an adhoc communications network, an adhoc communications network memory administration unit, an adhoc communications device, a method for operating an adhoc communications network and a method for operating an adhoc communications device.

### BACKGROUND

Efficient use of memory units in an adhoc communications network which act towards the outside in their totality as one unit is desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of embodiments. In the following description, various embodiments are described with reference to the following drawings, in which:

FIG. 1 shows an adhoc communications network with two communications devices and an external memory administration circuit according to an exemplary embodiment;

FIG. 2 shows an adhoc communications network with two communications devices and an internal memory administration circuit according to an exemplary embodiment;

FIG. 3 is an illustration of components of a memory administration unit according to an exemplary embodiment;

FIG. 4 is a message flowchart according to an exemplary embodiment;

FIG. 5 is a message flowchart according to another exemplary embodiment;

FIG. 6 is a message flowchart according to another exemplary embodiment;

FIG. 7 is a message flowchart according to yet another exemplary embodiment; and

FIG. 8 is a message flowchart according to a further exemplary embodiment.

### DESCRIPTION

In the description, the terms “connected” and “coupled” are used to describe both a direct and indirect connection as well as direct or indirect coupling. In the figures, identical or similar elements are provided with identical reference symbols as far as is expedient.

The Bluetooth wireless technology provides data rates of a maximum of 2.2 Mbit/s (net data rate with EDR (Enhanced Data Rate) during download). These data rates are sufficient for contemporary applications such as spontaneous local networking of mobile small devices (mobile telephones, PDAs etc.) with one another or of computers with their peripherals (keyboards, mice, printers etc.). However, this maximum data rate will no longer be able to satisfy future scenarios. New application fields for Bluetooth wireless technology, such as are currently under discussion in standardization Working Groups, are, for example, the synchronization of portable personal memory devices (classic example is the successful iPod products series from Apple) with extensive fixed multimedia databases. Synchronizing the audio contents and video contents, for example in the morning before the user sets out for work, will take the shortest possible time.

The Bluetooth SIG (Special Interest Group) has therefore set itself the objective of integrating a higher data rate into the existing Bluetooth wireless technology architecture for these future applications. A transmission technology which is suitable for this is UWB (ultra wideband). In March 2006, a cooperative venture with the WiMedia Alliance, in which a possible UWB variant will be standardized, was officially announced by the Bluetooth SIG. The objective of this cooperation is to be able to use, in addition to the physical Bluetooth transmission layer which has already become established in the market and has data rates of a maximum of 2.2 Mbit/s, also the physical UWB (ultra wideband) transmission layer of the WiMedia Alliance, which is based on OFDM (Orthogonal Frequency Division Multiplexing, a multi-carrier modulation method) for all already existing Bluetooth protocols and profiles. Furthermore, the integration of the UWB transmission technology is also intended to stimulate the development of new application profiles. In one exemplary embodiment, it is possible to integrate other alternative transmission technologies into the existing Bluetooth wireless technology architecture, for example the UWB variant according to the UWB forum standard, which is based on DSSS (Direct Sequence Spread Spectrum), or the WLAN (Wireless Local Area Network) technology according to the IEEE 802.11 radio transmission standard.

The Bluetooth SIG Working Group which has been entrusted with standardizing the Bluetooth technology (an example of a radio transmission technology in an adhoc communications network) not only defines the physical transmission methods and protocol layers but also application profiles (referred to as Bluetooth Profiles in English) which are intended to ensure that Bluetooth equipment from different manufacturers can cooperate. In such an application profile it is possible to define rules, protocols and data formats for a dedicated application scenario. In many cases it is possible to understand an application profile as being a vertical section through the entire protocol layer model in that it defines the obligatory protocol components for each protocol layer or defines application-profile-specific parameters for a specific protocol layer. As a result, a high degree of interoperability is ensured. In addition, by virtue of using application profiles the user has the advantage that he does not need to coordinate two or more terminals manually with one another. The most important application profile is the Generic Access Profile (GAP) with basic functions for connection setup and authentication, on which all the other application profiles are based.

Nowadays, many people already carry on their person a large number of different electronic devices such as digital cameras, mobile telephones, MP3 players, personal digital assistants (PDA) and similar equipment on a daily basis. Most of these devices support Bluetooth wireless technology and have at least one memory area which is available to the user of the respective device for storing or reading individual data. In some of these devices, the user can additionally plug in an external semipermanent storage medium and therefore increase the available memory space per device. In some cases, the external storage media differ considerably in format, capacity, access speeds and writing/reading speed since they are adapted in an optimum way to the respective application. “Semipermanent” may mean in this context “non-volatile”, i.e. that the digital information is stored both permanently and can, when necessary, be changed or deleted. Nowadays, what are referred to as flash memories are particularly popular as semipermanent electronic memories for storing individual multimedia data for mobile applications, said flash memories being available in a large number of different housing formats with different interfaces (for example compact flash card, multimedia card, secure digital card, etc.). Their technically precise designation is actually flash EEPROM. In contrast to a “conventional” EEPROM memory, in the case of a flash EEPROM the smallest addressable storage unit (a byte) cannot be deleted individually. The housings which are embodied as a memory card usually contain both the actual flash memory module and a controller module.

Even though it is possible to assume that the capacities of the individual memory units will also continue to increase in the future, it cannot necessarily be assumed that this development would also solve all storage problems for all times. The past has shown that the requirement for ever greater storage capacities is always prevalent. Even though at present a couple of music files in MP3 format or a digital camera resolution of two or three megapixels is still sufficient, in the future for reasons of convenience the user may wish to carry a large part of his audio and video library with him continuously and take photos with a resolution of at least ten megapixels.

People nowadays often have, without being conscious of the fact, a large number of memory areas in their direct vicinity which have until now been administered independently of one another and to a certain extent also have different properties which may be positive or negative. As a result of the planned “Bluetooth over UWB” extensions it is possible for these memory areas which are usually distributed among different devices to be joined together. It is therefore now the case that, for example, photographs which have been taken are automatically stored in an internal or external storage medium which is assigned to the digital camera. If this storage medium is full, it is not possible to store any more photographs. This is the case even if there are still sufficient free capacities with suitable properties in the totality of memory areas which are distributed among the different devices in the field of action of the close range radio technology used. This behavior is inefficient.

Table 1 includes a list with abbreviations which are frequently used in the exemplary embodiments of the invention later on in this description.

TABLE 1
List of Abbreviations

| Abbreviation | German term | English term |
|---|---|---|
| MU | Speichermodul | Memory module |
| MAU | Speicherverwaltungseinheit | Memory |
| | | Administration |
| | | Unit |
| CMAU | Zentrale Speicherverwaltungseinheit | Central Memory |
| | | Administration |
| | | Unit |
| EPU | Ereignisverarbeitungseinheit | Event |
| | | Processing Unit |
| QU | Abfrageeinheit | Query Unit |
| CU | Recheneinheit | Calculation |
| | | Unit |
| DBᵢₙₜ | Interne Datenbank | Internal Database |
| D | Gerät | Device |

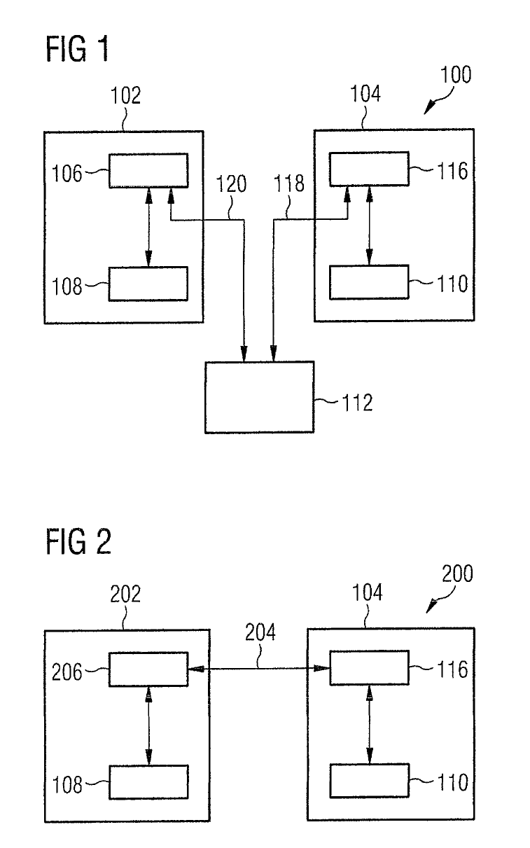

FIG. 1 shows an adhoc communications network 100 according to an exemplary embodiment with a first adhoc communications device 102 which has at least a first memory unit 108 and a memory access control unit 106, a second adhoc communications device 104, which has at least a second memory unit 110 and a second memory access control unit 116, and a memory administration unit 112 according to an exemplary embodiment of the invention. Furthermore, the first adhoc communications device 102 contains a communications device-internal memory access control unit 106 configured to control access to the at least one first memory unit 108. The second adhoc communications device 104 contains a memory access control unit 116 configured to control access to the at least one second memory unit 110.

An adhoc communications network is to be understood, for example, as an arrangement which is composed of at least two mobile adhoc communications devices and which does not require a fixed infrastructure.

A memory unit (MU) is an electronic memory in the widest sense for storing files of any type. An adhoc communications device (device, Dx) can respectively be assigned a plurality of memory units MU_{xA} to MU_{xZ} with different properties.

The memory administration unit 112 is configured to administer jointly the first memory unit 108 in the first adhoc communications device 102 and the second memory unit 110 in the second adhoc communications device 104.

For this purpose, the memory administration unit 112 uses an adhoc communications protocol to communicate with the memory access control units 106 of the first adhoc communications device 102 via the communications connection 120, and with the memory access control units 106 of the second adhoc communications device 104 via the communications connection 118. The communications connections can, according to one exemplary embodiment, be embodied in a wireless fashion, for example according to a close range radio protocol. An example of a close range radio protocol is the Bluetooth radio communications protocol.

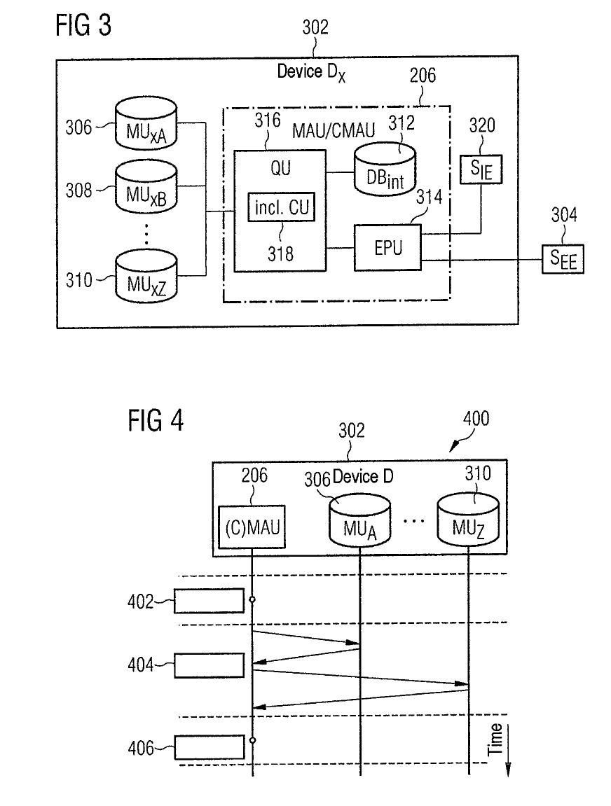

According to one exemplary embodiment, memory-specific information relating to the memory units 108 and 110 or the data to be stored itself is exchanged via the communications connections 120 and 118. The memory administration unit 112 is explained in more detail below in a following exemplary embodiment with reference to FIG. 3.

In one exemplary embodiment the memory-specific information contains the following parameters:
classification features (for example hard disk or flash memory etc.);
memory space availability (for example from the point of view of the memory unit: current, predicted etc.);
memory space requirement (for example from the point of view of the application which would like to store data);
access speeds (for example maximum permitted access times, necessary writing and reading speeds etc.);
particular requirements of the memories in terms of, for example, integrity of the data;

safety aspects (for example suitability for different DRM technologies for (copyright) protection of the contents and rights of use etc.);

other capabilities/properties.

The categorization described above describes an exemplary selection of parameters which can be used to administer the memory units 108 and 110, respectively, of the adhoc communications devices 102 and 104, respectively.

This ensures that memory-specific information is exchanged between different devices within an adhoc network. As a result of this appropriate logic operations are carried out on memory units which are distributed among different devices, for the purpose of more efficient memory administration and memory use.

According to one exemplary embodiment, the first adhoc communications device 102 is configured to communicate with the memory administration unit 112 via the communications connection 120 according to a wireless adhoc communications protocol, for example using a close range radio adhoc communications protocol, for example a Bluetooth protocol.

According to a further exemplary embodiment, the second adhoc communications device 104 is configured to communicate with the memory administration unit 112 via the communications connection 118 according to a wireless adhoc communications protocol, for example using a close range radio adhoc communications protocol such as, for example, a Bluetooth protocol.

Adhoc communications devices which exchange information using different protocols can, according to one exemplary embodiment, be arranged in hybrid communications networks.

The communications connections 120 and 118 are understood to be a logic connection in one exemplary embodiment. The communications connections 120 and 118 can, in this case, also in particular constitute indirect connections via further adhoc communications devices.

In one exemplary embodiment, the memory administration unit 112 is configured to select the first storage module 108 or the second storage module 110 to store the data to be stored, taking into account the type of data to be stored.

According to a further exemplary embodiment, the memory administration unit 112 can select the first memory unit 108 or the second memory unit 110 depending on the type of the first memory unit 108 (in other words according to the properties of the first memory unit 108) or depending on the type of the second memory unit 110 (in other words according to the properties of the second memory unit 110).

The memory administration unit 112 can, as shown in FIG. 1, be located either outside the first adhoc communications device 102 or outside the second adhoc communications device 104. According to one exemplary embodiment, the memory administration unit 112 can, however, also be arranged in the first adhoc communications device 102 or in the second adhoc communications device. This case is illustrated in an exemplary embodiment in FIG. 2.

FIG. 2 shows an adhoc communications network 200 with a second adhoc communications device 104 which corresponds to that of the exemplary embodiment in FIG. 1, and has a memory access control unit 116 and a memory unit 110. The first adhoc communications device 202 also has a memory unit 108 and a memory access control unit 206. In this exemplary embodiment, the memory access control unit 206 is configured to operate as a memory administration unit for jointly administering at least one memory unit 108 of the first adhoc communications device 202 and of the at least one memory unit 110 of the second adhoc communications device 104 using an adhoc communications protocol. In this context, the communication is carried out via the communications connection 204 according to an adhoc communications protocol.

According to one exemplary embodiment, the communications connection 204 can in turn also be considered in this case as a logic connection in which the physical connection extends via further adhoc communications devices (not illustrated in FIG. 2).

In this context, according to one exemplary embodiment, the adhoc communications device 202 and the adhoc communications device 204 can use different communications protocols. In this case, the different protocols are translated into the respective other communications protocol, for example in one of the further adhoc communications devices.

The combined memory administration and memory access control unit 206 of the first adhoc communications device 202 is configured in one exemplary embodiment to select the at least one first memory unit 108 or the at least one second memory unit 110 of the second adhoc communications device 104 for storing data which is to be stored, taking into account the type of the at least one first memory unit 108 (in other words taking into account the properties of the at least one first memory unit 108) or the type of the at least one second memory unit 110 (in other words taking into account the properties of the at least one second memory unit 110) or the type of the data itself which is to be stored (in other words taking into account the condition of the data itself which is to be stored).

The effects of the exemplary embodiments of the invention are inter alia:
The individual memory units are used more efficiently.
The totality of all the memory units acts towards the outside as one unit.
The user is relieved of the burdensome task of deciding himself which data is to be stored where. In particular, users who are less familiar with the technology are quickly overtaxed by such tasks.
Memory areas can be classified in accordance with their different properties so that the optimum memory space can always be determined for a specific type of file.

In addition, the expectations of the Bluetooth SIG in terms of development of new Bluetooth application profiles which make use of the integration of the UWB transmission technology are met.

FIG. 3 shows a detailed design of a memory administration unit with the connection of internal and external event sensors S_{IE} 320 and S_{EE} 304 as well as a plurality of memory units MU_{xA} 306 to MU_{xZ} 310 in the access area within a device Dₓ 302, for example an adhoc communications device according to the invention in an adhoc communications network.

If the present network is a Bluetooth Pico network or Scatternet, the following assumptions are made:
The distribution of roles (in terms of master and slave) of the devices D₀ to Dₙ, which form a Bluetooth network, is already conclusively defined.
The device Do is assigned, by way of example, the role of a Bluetooth master, while all the other devices D₁ to Dₙ have the role of a Bluetooth slave.
The device D₀ (here Bluetooth master) also performs, for reason of clarity, the function of the central memory administration unit CMAU whose tasks are described further below.

If the selected close range radio technology is a Bluetooth Pico network, the method which is presented here can be implemented as a Bluetooth profile in order to allow the memory unit distributed in the network to act towards the outside as one unit.

According to an embodiment, the memory administration units MAU and CMAU 206 can determine the current properties or states of the memory units MUₓ 306, 308, 310 in their respective response areas (i.e. as a rule within the corresponding device) both when a previously defined internal or external event occurs (an internal event is, for example, the generation of a photograph with the device 302 which is to be stored; an external event is, for example, the occurrence of a memory request from another device in the network) and continuously/periodically/sporadically during ongoing operation. Depending on the application both can be appropriate. FIG. 3 shows the design of a memory administration unit (C) MAU 206 in detail: It is composed of an event processing unit EPU 314 which is connected to the internal and external sensors S_{IE} 320 and S_{EE} 304 and can be informed by them about the occurrence of specific events. In addition, said unit may contain a separate internal database DBᵢₙₜ 312 in which the relevant properties or states which are determined for all the memory units MU_{xA} to MU_{xZ} 306, 308, 310 which are located in their area of influence can be stored. The interrogation of the properties or states is performed by the query unit QU 316, which is also illustrated in FIG. 3. Properties of memory units 306, 308, 310 are to be understood within the scope of this description as static variables (for example hard disk or flash memory) which are usually predefined by the design and do not change during operation; states of memory units 306, 308, 310 are to be understood within the scope of this description as dynamic variables (for example available memory space at the time of the query). According to one exemplary embodiment, the memory administration unit 206 is also capable of calculating a resulting memory profile from the individual properties or states of all the memory units MU_{xA} to MU_{xZ} 306, 308, 310 which are in its field of influence (for example by summing the individual memory capacities). This can be implemented, for example, by means of the calculation unit 318 which is characterized by CU and which, for reasons of simplicity, is assigned in FIG. 3 to the query unit QU 316. The results of the calculations can in turn be stored in the internal database DBᵢₙₜ 312. It may be advantageous to interrogate in advance the physically predefined static properties of the individual memory units MUₓ 306, 308, 310 and to store them in the database DBᵢₙₜ 312 within the memory administration units MAU and CMAU 206 for the purpose of quick access for comparison operations by the computing unit CU 318. In contrast, it appears advantageous to interrogate the current states of the individual memory units MUₓ 306, 308, 310 on an up to date basis where necessary since they are generally subjected to dynamic fluctuations during ongoing operation.

FIG. 4 shows a message flowchart (transaction diagram) 400 according to an exemplary embodiment for the case in which the static storage properties of the (central) memory administration unit (C) MAU 206 are determined immediately after the device 302 is connected.

In 402, the device D 302 is switched on. The (central) memory administration unit (C) MAU 206 subsequently determines, in 404, the properties of all the memory units in its area of responsibility. In this example, the area of responsibility of the (central) memory administration unit (C) MAU is the memory units MU_{A} 306 to MU_{z} 310. From the properties which are determined for all the memory units 306, 308, 310 in its field of responsibility it is possible for the (central) memory administration unit (C) MAU 206 to calculate, in 406, a resulting memory profile with respect to the properties of all the memory units MU_{A} 306 to MU_{z} 310 located in its field of influence, using the calculation unit CU 318 described above.

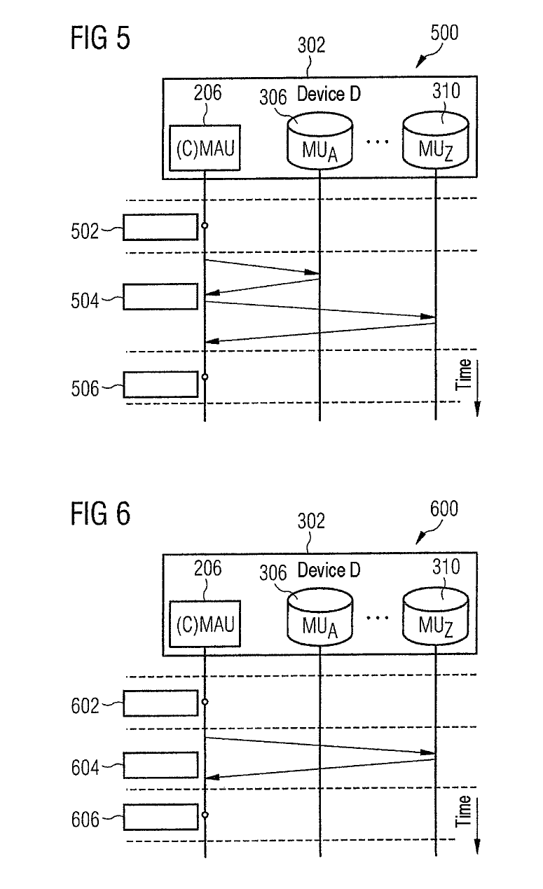

FIG. 5 shows a message flowchart (transaction diagram) 500 according to an exemplary embodiment for the case in which the dynamic storage properties of the (central) memory administration unit (C) MAU 206 are determined during ongoing operation when a defined event occurs.

The previously defined event occurs in 502. The (central) memory administration unit (C) MAU 206 subsequently determines, in 504, the properties of all the memory units in its field of responsibility. In this example, the field of responsibility of the (central) memory administration unit (C) MAU 206 includes the memory units MU_{A} 306 to MU_{z} 310. From the properties which are determined for all the memory units 306, 308, 310 in its field of responsibility it is possible for the (central) memory administration unit (C) MAU 206 to calculate, in 506 a resulting memory profile with respect to the properties of all the memory units MU_{A} 306 TO MU_{z} 310 located in its field of influence using the calculation unit CU 318 described above.

FIG. 6 is a message flowchart (transaction diagram) 600 according to an exemplary embodiment showing the accessing of a memory unit, for example the memory unit MU_{z} 310 by a (central) memory administration unit (C) MAU 206 for the purpose of storing or reading out data.

In 602, the (central) memory administration unit (C) MAU 206 is informed that memory unit MU_{z} 310 is to be accessed, for example for the purpose of storing data. Previously, the memory administration unit in device D 302 may either have calculated this information itself or else have been supplied with this information by another (central) memory administration unit (C) MAU 206 in another device, for example the adhoc communications device 104 in FIG. 2, for example using a close range radio technology. In 604, the actual access process is described, for example a memory process. It is apparent here that the data is either transferred from the memory administration unit MAU 206 to the memory unit MU_{z} 310 (storage) or transferred from the memory unit MU_{z} 310 to the memory administration unit MAU 206 (read out). In 606 this process is concluded, i.e. the data has been successfully stored or read out.

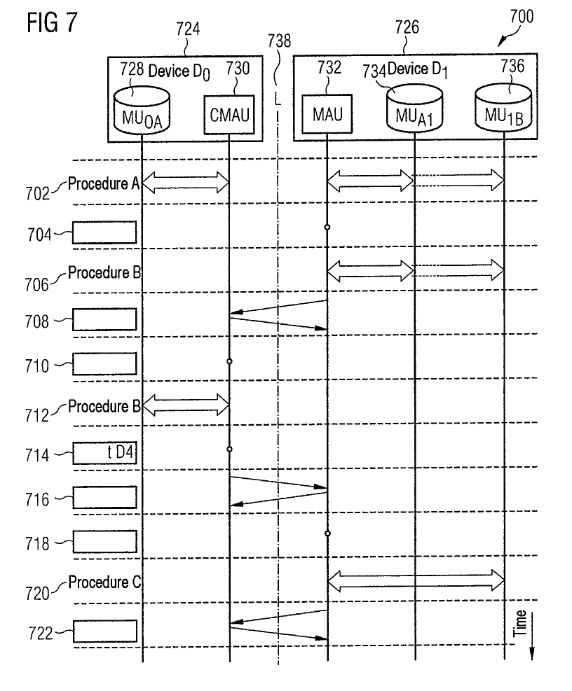

FIG. 7 shows a message flowchart (transaction diagram) 700 according to an exemplary embodiment for the case in which
a file to be stored is generated in device D₁ 726,
the central memory administration unit CMAU 730 is located in device D₀ 724, and
the memory unit MU_{1B} 736 which is most suitable for storing the file is located in device D₁ 726.

Any exchange of information between the two devices D₀ 724 and D₁ 726 takes place via the air interface L 738 (highlighted in FIG. 7) which is configured for example as close range radio technology. Only these transactions could, according to one exemplary embodiment, be implemented as a Bluetooth profile. All the other transactions are handled by means of device-internal interfaces (procedures A 702, B 706 and 712 as well as C 720). Since the entirety of all the transactions is significant for smooth running of the method according to an embodiment, FIG. 7 shows both the transactions via the air interface L 738 and the internal transactions, for example for interrogating the properties or states of the memory units 728, 734, 736 or for the purpose of accessing a memory unit 728, 734, 736.

Procedure A 702: According to the exemplary embodiment in FIG. 4 the properties of the individual memory units 728, 734 and 736 are determined. This is done, for example, directly after the devices 724 and 726 have been switched on or immediately after the setting up of a network connection within the scope of the close range radio technology used.

In 704, the memory administration unit MAU 732 is provided with knowledge in device D₁ 726 (for example via an internal sensor S_{IE} 320, see FIG. 3), that data is present for storage. The memory administration unit MAU 732 can obtain some of the properties of the data via the sensors S_{IE} 320 and S_{EE} 304 (see FIG. 3) (for example file type=“still image”, file format=“JPEG”, file size=“600 kB”). In addition, the sensors 320, 304 of the memory administration unit MAU 732 can also convey particular requirements of the data source (for example the application, hardware components etc.).

Procedure B 706: According to the exemplary embodiment in FIG. 5 the current states of the individual memory units 734, 736 which are assigned to the device D₁ 726 are determined. Within the scope of this example, the following is assumed: Memory unit MU_{1A} 734 signals “100 kB still currently available”, while memory unit MU_{1B} 736 signals “200 MB still currently available” and “the average access time is 20 ms”.

In 708, the memory administration unit MAU 732 in device D₁ 726 communicates to the central memory administration unit CMAU 730 in device D₀ 724 that an event has occurred and communications what requirements the event makes of the totality of memory units 728, 732, 736 which are distributed in the system. Furthermore, the memory administration unit MAU 732 can cause information indicating how the resulting memory profile of the device D₁ 726 which is composed of the individual memory units MU_{1A} 734 and MU_{1B} 736 looks or how the individual memory unit profiles look, to be transmitted from device D₁ 726 of the central memory administration unit CMAU 730 into device D₀ 724.

Tables 2 and 3 show a possible design of the pair of messages from 708, in which the message of the type Storage_RES (see table 3) serves only to transmit back feedback to the device D₁ 726. According to one exemplary embodiment, at least the following information elements are contained in the messages:

TABLE 2
Information elements in the message Storage_REQ

| Information | | |
|---|---|---|
| element | Presence | Description |
| Type of message | Obligatory | Identifies this message as Storage_REQ |
| Transaction | Obligatory | Characterizes the |
| feature | | association of a pair of messages |
| Version code | Obligatory | Indicates the version number of the |
| | | protocol used |
| Device ID | Optional | Identification feature of transmitting |
| | | device |
| Event ID | Obligatory | Identification feature for the event |
| Type of event | Optional | Storage, overwriting, reading etc. |
| File information | Obligatory | Storage requirements of the event |
| | | caused by the file to be stored |
| | | (file type, file size) |
| Application | Obligatory | Storage requirements of the event |
| | | caused by the type of application |
| information | | (access speeds, DRM protection) |
| Memory unit MU_{1A} | Optional | Contains properties and states of |
| | | the 1st memory unit |
| . . . | Optional | . . . |
| Memory unit MU_{In} | Optional | Contains properties and states of the |
| | | nth memory unit |
| Resulting | Optional | Contains compiled properties and states |
| Memory profile | | of all the memory units in device |
| | | D₁ (734) |

TABLE 3
Information elements in the message Storage_RES

| Information | | |
|---|---|---|
| element | Presence | Description |
| Type of message | Obligatory | Identifies this message as Storage_RES |
| Transaction | Obligatory | Characterizes the association of a pair |
| feature | | of messages. |
| Version code | Obligatory | Indicates the version number of the |
| | | protocol used. |
| Status | Obligatory | Describes the status of the message |
| | | Storage_REQ |
| Status text | Optional | Can contain additional status |
| | | information. |

The reception of the message Storage_REQ sent by device D, 724 is itself the trigger for device D₀ 724 for comparison operations in 710 and for the execution of the procedure B 712 for determining the current states of those memory units which are included in the field of action of device D₀ 724 (here memory unit MU_{0A} 728) in order then to be able to carry out comparison operations. Within the scope of this example it is assumed that the memory unit MU_{0A} 728 signals the “average access time is 185 ms”.

In 714, the central memory administration unit CMAU 730 consequently has both the properties and/or states of the memory unit 734, 736 from device D₁ 726 and the properties and/or states of the memory units 728 from device D₀ 724 for comparison operations. In this highly simplified example, the central memory administration unit CMAU 730 decides by reference to the four information data records which are determined:
the average access time to MU_{0A} 728 is 185 ms,
the memory space which is currently still available in MU_{1A} 734 is 100 kB,
the memory space which is currently still available in MU_{1B} 736 is 200 MB, and
the average access time to MU_{1B} 736 is 20 ms,

that the memory unit MU_{1B} 736 is most suitable for storing the file with a size of 600 kB. Of course, more complex comparison operations in accordance with the other abovementioned criteria and/or further criteria may also be conceivable and appropriate.

In 716, the central memory administration unit CMAU 730 transmits, in device D₀ 724, the result of its calculations (specifically as a command) to the memory administration unit MAU 732 in device D₁ 726. The tables 4 and 5 show a possible structure of the pair of messages from 716, with the message of the type Command_RES (see table 5) serving merely to transmit back feedback to the device D₀ 724. According to one exemplary embodiment, at least the following information elements are contained in the messages:

TABLE 4
Information elements in the message Command_REQ.

| Information | | |
|---|---|---|
| element | Presence | Description |
| Type of message | Obligatory | Identifies this message as |
| | | Command_REQ |
| Transaction | Obligatory | Characterizes the association of |
| feature | | a pair of messages |
| Version code | Obligatory | Indicates the version number of the |
| | | protocol used |
| Device ID | Optional | Identification feature of the |
| | | receiving device |
| Event ID | Obligatory | Identification feature for the event |
| Result of | Obligatory | Decision how the event or the data |
| Calculation | | which has produced the event is to |
| | | be handled |
| Resulting memory | Optional | Contains compiled properties and |
| Profile | | states of all the memory units in |
| | | device D₀ 724 |

TABLE 5
Information elements in the message Command_RES.

| Information | | |
|---|---|---|
| Element | Presence | Description |
| Type of message | Obligatory | Identifies this message as |
| | | Command_RES. |
| Transaction | Obligatory | Characterizes the association of a |
| feature | | pair of messages |
| Version code | Obligatory | Indicates the version number of the |
| | | protocol used |
| Status | Obligatory | Describes the status of the message |
| | | Command_REQ |
| Status text | Optional | Can contain additional status |
| | | information |

In 718, the memory administration unit MAU 732 in device D₁ 726 receives the result of the calculations of the central memory administration unit CMAU 730 in device D₀ 724 (for example in the form of specific commands). Optionally, the memory administration unit MAU 732 in device D₁ 726 can carry out its own calculations once more at this point.

Procedure C 720: According to the exemplary embodiment in FIG. 6 the data which have caused the event are stored in this step according to the commands from the message of the type Command_REQ (information element “result of calculation”) in the memory unit MU_{1B} 736.

722 serves to inform the central memory administration unit CMAU 730 in device D₀ 724 about the execution of the command transmitted in 716 in device D₁ 726. The tables 6 and 7 show a possible structure of the pair of messages from 722, with the message of the type Outcome_RES (table 7) serving merely to acknowledge the reception of the message Outcome_REQ from the device D₀ 724. According to an exemplary embodiment, at least the following information elements are contained in the messages:

TABLE 6
Information elements in the message Outcome_REQ.

| Information | | |
|---|---|---|
| element | Presence | Description |
| Type of message | Obligatory | Identifies this message as Outcome_REQ |
| Transaction | Obligatory | Characterizes the association of a pair |
| feature | | of messages |
| Version code | Obligatory | Indicates the version number of the |
| | | protocol used |
| Device ID | Optional | Identification feature of the |
| | | transmitting device |
| Event ID | Obligatory | Identification feature for the result |
| Result | Obligatory | Information about the execution of the |
| | | commands contained in the message |
| | | Command_REQ |
| Path indication | Optional | Information about the precise storage |
| | | location for the later access by device |
| | | D₀ 724 of the data records stored in |
| | | device D₁ 726 |

TABLE 7
Information elements in the message Outcome_RES.

| Information | | |
|---|---|---|
| element | Presence | Description |
| Type of message | Obligatory | Identifies this message as Outcome_RES |
| Transaction | Obligatory | Characterizes the association of a pair |
| feature | | of messages |
| Version code | Obligatory | Indicates the version number of the |
| | | protocol used |
| Status | Obligatory | Describes the status of the message |
| | | Outcome_REQ |
| Status text | Optional | Can contain additional status |
| | | information |

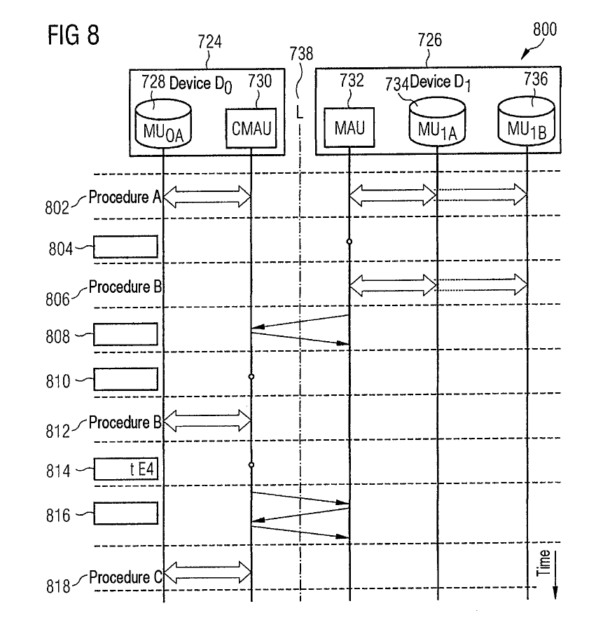

FIG. 8 shows a message flowchart (transaction diagram) 800 according to an exemplary embodiment for the case in which
a file which is to be stored is generated in device D₁ 726,
the central memory administration unit CMAU 730 is in device D₀ 724, and
the memory unit MU_{0A} 728 which is most suitable for storing the file is in device D₀ 724 and the data therefore has to be transmitted from D₁ 726 to D₀ 724.

To simplify it is assumed that the first steps in the message flowchart 800 to 814 occur precisely as in the message flowchart 700 in the exemplary embodiment according to FIG. 7. However, in this example the calculation of the commands from the properties and states which are determined for the memory units 728, 734, 736 distributed in the system occur differently in 814: The central memory administration unit CMAU 730 decides by reference to the following information data records which are determined by way of example
the currently still available memory space in MU_{0A} 728 is 200 MB,
the average access time to MU_{0A} 728 is 20 ms,
the currently still available memory space in MU_{1A} 734 is 100 kB,
the currently still available memory space in MU_{1B} 736 is 15 GB, and
the average access time to MU_{1B} 736 is 230 ms,

that the memory unit MU_{0A} 728 is most suitable for storing the file with a size of 600 kB. Of course, as already mentioned above, more complex comparison operations with other criteria and/or further criteria may also be conceivable and appropriate.

In 816, the memory administration unit MAU 732 in device D₁ 726 is therefore informed that it should cause the data which has triggered the current event to be transmitted from device D₁ 726 to the device D₀ 724. The tables 8 to 10 show a possible structure of the message triple from 816, in which case the message of the type Command_2_REQ (table 8) can be identical in terms of structure to the message Command_REQ defined in table 4 and the message Data_Transfer_REQ serves to transmit the data over the air interface L 738, and the message Data_Transfer_RES serves merely to send back feedback to the device D₁ 726. According to an embodiment, at least the following information elements are to be contained in the messages.

TABLE 8
Information elements in the message Command_2_REQ

| Information | | |
|---|---|---|
| element | Presence | Description |
| Type of message | Obligatory | Identifies this message as |
| | | Command_2_REQ |
| Transaction | Obligatory | Characterizes the association of a |
| feature | | triple of messages |
| Version code | Obligatory | Indicates the version number of the |
| | | protocol used |
| Device ID | Optional | Identification feature of the |
| | | receiving device |
| Event ID | Obligatory | Identification feature for the event |
| Result of | Obligatory | Decision as to how the event or the |
| calculation | | data which has caused the event |
| | | needs to be handled |
| Resulting | Optional | Contains compiled properties and |
| storage | | states of all the memory units in |
| profile | | device D₀ 724 |

TABLE 9
Information elements in the message Data_Transfer_REQ

| Information | | |
|---|---|---|
| element | Presence | Description |
| Type of message | Obligatory | Identifies this message as |
| | | Data_Transfer_REQ |
| Transaction | Obligatory | Characterizes the association of a |
| feature | | message triple |
| Version code | Obligatory | Indicates the version number of the |
| | | protocol used |
| Data | Obligatory | Contains the data which has triggered |
| | | the event in the device D₁ 726 and is |
| | | to be transmitted to the device D₀ |
| | | 724 |

TABLE 10
Information elements in the message Data_Transfer_RES

| Information | | |
|---|---|---|
| element | Presence | Description |
| Type of message | Obligatory | Identifies this message as |
| | | Data_Transfer_RES |
| Transaction | Obligatory | Characterizes the association of a |
| feature | | message triple |
| Version code | Obligatory | Indicates the version number of the |
| | | protocol used |
| Status | Optional | Describes the status of the message |
| | | Data_Transfer_REQ |
| Status text | Optional | Can contain additional status |
| | | information |

Procedure C 818: According to the exemplary embodiment in FIG. 6 the data which has caused the event and which has been transmitted in the message Data_Transfer_REQ over the air interface L 738 is stored in 818 in the memory unit MU_{0A} 718.

The message flowchart 800 can optionally be terminated with the message of the type Outcome_REQ (table 6) and Outcome_RES (table 7) defined in the exemplary embodiment according to FIG. 6 (message flowchart 600) in order to indicate to the device D₁ 726 whether the storage of the data in device D₀ 724 was successful and/or in order to transmit to the device D₁ 726 more detailed information about the storage location of the data in the device D₀ 724. This transaction is not illustrated in FIG. 8 for reasons of better clarity.

Table 11 contains a comparative listing of all the messages defined in this description. In this case, the transmission direction of each message (from a device D₀ 724 with a central memory administration unit CMAU 730 to a device D₁ 726 with a memory administration unit MAU 732 or vice versa) is also listed. The message flowcharts 400, 500, and 600 do nor appear in table 11 since they only describe internal transactions which do not require implementation over the air interface 738.

TABLE 11
Overview of the messages defined in this signaling
system according to an embodiment.

| | | Transmission | | | | | | |
|---|---|---|---|---|---|---|---|---|
| Type of | | Direction | | Use in flowchart | | | | |
| message | Table | D₀ [symbol] D₁ | D₁ [symbol] D₀ | A | B | C | D | E |
| Storage_REQ | 2 | | x | n.a. | n.a. | n.a. | x | X |
| Storage_RES | 3 | x | | n.a. | n.a. | n.a. | x | X |
| Command_REQ | 4 | x | | n.a. | n.a. | n.a. | x | |
| Command_RES | 5 | | x | n.a. | n.a. | n.a. | x | |
| Outcome_REQ | 6 | | x | n.a. | n.a. | n.a. | x | (x) |
| Outcome_RES | 7 | x | | n.a. | n.a. | n.a. | x | (x) |
| Command_2_REQ | 8 | x | | n.a. | n.a. | n.a. | | X |
| Data_Transfer_{—} | 9 | | x | n.a. | n.a. | n.a. | | X |
| REQ | | | | | | | | |
| Data_Transfer_{—} | 10 | x | | n.a. | n.a. | n.a. | | X |
| RES | | | | | | | | |

The categorization/classification of data described at the beginning permits the user of course to switch the method on and off for specific file types or file formats independently of one another so that, for example, files which comprise address book entries and are of the type vCard are stored exclusively in the user's mobile telephone.
The data stored distributed in the entire system is easily read out by using the information about the precise storage location (information element “path indication”).
The information element “device ID” in the messages defined here is optional since it is possible to assume therefrom that the addressing of the transmitting device and receiving device can be taken over completely by the lower protocol layers. This applies in particular to the case in which the close range radio technology used is a Bluetooth Pico network in which the role distributions in terms of master and slave are already concluded.

In one exemplary embodiment of the invention, a method is provided for exchanging memory-specific information about the memory units between a plurality of adhoc communications units which form a network. A memory administration unit which can be arranged in one of these communications units or externally administers the memory units centrally in the adhoc communications units of the adhoc network so that an adhoc communications unit can use data in the entire memory available in the adhoc network efficiently and without intervention by the user. This is done in further exemplary embodiments taking into account information about, inter alia, the type of memories, the type of data, the size of the file to be stored, the available memory space in the memory units and the access times.

The described methods can be used, for example, in a wireless adhoc communications network. If the selected close range transmission technology is a Bluetooth Pico network, the method presented here can be implemented as a separate Bluetooth application profile.

In an embodiment, an adhoc communications network is provided. The adhoc communications network may include at least two adhoc communications devices having at least one memory unit each, and a memory administration unit which is configured to jointly administer the two memory units of the at least two adhoc communications devices using an adhoc communications protocol.

In an example of this embodiment, at least one memory unit of the at least two adhoc communications devices is configured for communication according to a wireless adhoc communications protocol. In another example of this embodiment, at least one memory unit of the at least two adhoc communications devices is configured for communication according to a close range radio adhoc communications protocol. In yet another example of this embodiment, at least one memory unit of the at least two adhoc communications devices is configured for communication according to a Bluetooth adhoc communications protocol. In another example of this embodiment, the memory administration unit is configured to select a memory unit from the at least two memory units for storing data which is to be stored, taking into account predefined peripheral conditions. Further in this embodiment, the predefined peripheral conditions may be at least partially formed from the following criteria: Properties of at least one memory unit of the at least two memory units, and/or state of at least one memory unit of the at least two memory units, and/or condition of the data to be stored, and/or requesting of at least one application to at least one memory unit. Further in this embodiment, the memory administration unit may be contained in an adhoc communications device of the at least two adhoc communications devices.

In an embodiment, an adhoc communications network memory administration unit is provided. The adhoc communications network memory administration unit may be configured to jointly administer at least two memory units, wherein in each case a memory unit is contained in a respective adhoc communications device of at least two adhoc communications devices. In an example of this embodiment, the adhoc communications network memory administration unit may be configured to select a memory unit from the at least two memory units for storing data to be stored, taking into account predefined peripheral conditions. In an implementation of this embodiment, the predefined peripheral conditions may be at least partially formed from the following criteria: Properties of at least one memory unit of the at least two memory units, and/or state of at least one memory unit of the at least two memory units, and/or condition of the data to be stored, and/or requesting of at least one application to at least one memory unit. In another example of this embodiment, the memory administration unit is contained in an adhoc communications device of the at least two adhoc communications devices.

In another embodiment, an adhoc communications device is provided. The adhoc communications device may include at least one memory unit, a communications device—internal memory access control unit configured to control access to the at least one memory unit, wherein the memory access control unit is configured to communicate with a memory administration unit using an adhoc communications protocol. In an example of this embodiment, the memory access control unit is configured to communicate with a communications device—external memory administration unit using an adhoc communications protocol. In another example of this embodiment, the adhoc communications device may be configured to communicate according to a wireless adhoc communications protocol. In yet another example of this embodiment, the adhoc communications device may be configured to communicate according to a close range radio adhoc communications protocol. Furthermore, in an implementation of this embodiment, the adhoc communications device may be configured to communicate according to a Bluetooth adhoc communications protocol. In another example of this embodiment, the memory access control unit may be configured to select a memory unit from the at least one memory unit for storing data to be stored, taking into account predefined peripheral conditions. In yet another example of this embodiment, the predefined peripheral conditions are at least partially formed from the following criteria: Properties of the at least one memory unit, and/or state of the at least one memory unit, and/or condition of the data to be stored, and/or requesting of at least one application to at least one memory unit. Furthermore, in another example of this embodiment, the memory access control unit is configured to determine the peripheral conditions.

In another embodiment, an adhoc communications device is provided. The adhoc communications device may include at least one memory unit, and a communications device-internal memory access control unit configured to control access to the at least one memory unit, wherein the memory access control unit is configured to operate as a memory administration unit for jointly administering the at least one memory unit and at least one memory unit of another adhoc communications device using an adhoc communications protocol. In an example of this embodiment, the adhoc communications device may be configured to communicate according to a wireless adhoc communications protocol. In another example of this embodiment, the adhoc communications device may be configured to communicate according to a close range radio adhoc communications protocol. In yet another example of this embodiment, the adhoc communications device may be configured to communicate according to a Bluetooth adhoc communications protocol. In an implementation of this embodiment, the memory access control unit may be configured to select the at least one memory unit of the adhoc communications device or the at least one memory unit of the other adhoc communications device for storing data to be stored, taking into account the properties of the memory units. In another example of this embodiment, the memory access control unit may be configured to select a memory unit from the at least one memory unit for storing data to be stored, taking into account predefined peripheral conditions. The predefined peripheral conditions may be at least partially formed from the following criteria: Properties of the at least one memory unit, and/or state of the at least one memory unit, and/or condition of the data to be stored, and/or requesting of at least one application to at least one memory unit. In another example of this embodiment, the memory access control unit may be configured to determine the peripheral conditions.

In another embodiment, an adhoc communications device may include at least one memory unit and a memory administration unit which is configured to jointly administer the at least one memory unit and at least one memory unit of another adhoc communications device using an adhoc communications protocol.

In another embodiment, a method for operating an adhoc communications network is provided. The method may include a common administration system for at least one memory unit of a first adhoc communications device and at least one memory unit of a second adhoc communications device using an adhoc communications protocol. In an example of the method of this embodiment, the communication between the first adhoc communications device and the second adhoc communications device may be carried out according to a wireless adhoc communications protocol. Furthermore, in an implementation of this embodiment, the communication between the first adhoc communications device and the second adhoc communications device may be carried out according to a close range radio adhoc communications protocol. In an example of this method, the communication between the first adhoc communications device and the second adhoc communications device may be carried out according to a Bluetooth adhoc communications protocol. In yet another example of this embodiment, for the storage of data to be stored, the memory unit of the first adhoc communications device or the memory unit of the second adhoc communications device may be selected taking into account predefined peripheral conditions. The predefined peripheral conditions may be at least partially formed from the following criteria: Properties of the at least one memory unit, and/or state of the at least one memory unit, and/or condition of the data to be stored, and/or requesting of at least one application to at least one memory unit. In another example of this embodiment, the peripheral conditions of at least one adhoc communications device of the two adhoc communications devices may be determined individually. In yet another example of this embodiment, the peripheral conditions of data which is to be stored for each adhoc communications device of the two adhoc communications devices in order to determine the storage space may be considered individually.

In another embodiment, a method for operating an adhoc communications device is provided. The method may include control of the access to at least one communications device—internal memory unit by means of a communications device—internal memory access control unit, wherein the memory access control unit is operated as a memory administration unit for jointly administering the at least one memory unit and at least one memory unit of another adhoc communications device.

while the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An adhoc communications network, comprising:
at least two adhoc communications devices, each having at least one memory unit; and
a memory administration unit which is configured to jointly administer the two memory units of the at least two adhoc communications devices using an adhoc communications protocol.

2. The adhoc communications network as claimed in claim 1,
wherein at least one memory unit of the at least two adhoc communications devices is configured for communication according to a wireless adhoc communications protocol.

3. The adhoc communications network as claimed in claim 2,
wherein at least one memory unit of the at least two adhoc communications devices is configured for communication according to a close range radio adhoc communications protocol.

4. The adhoc communications network as claimed in claim 3,
wherein at least one memory unit of the at least two adhoc communications devices is configured for communication according to a Bluetooth adhoc communications protocol.

5. The adhoc communications network as claimed in claim 1,
wherein the memory administration unit is configured to select a memory unit from the at least two memory units for storing data which is to be stored, taking into account predefined peripheral conditions.

6. The adhoc communications network as claimed in claim 5,
wherein the predefined peripheral conditions are at least partially formed from the following criteria:
Properties of at least one memory unit of the at least two memory units;
State of at least one memory unit of the at least two memory units;
Condition of the data to be stored; and
Requesting of at least one application to at least one memory unit.

7. The adhoc communications network as claimed in claim 1,
wherein the memory administration unit is contained in an adhoc communications device of the at least two adhoc communications devices.

8. An adhoc communications network memory administration unit, configured to jointly administer at least two memory units respectively located in the at least two adhoc communications devices.

9. The adhoc communications network memory administration unit as claimed in claim 8,
configured to select a memory unit from the at least two memory units for storing data to be stored, taking into account predefined peripheral conditions.

10. The adhoc communications network memory administration unit as claimed in claim 9,
wherein the predefined peripheral conditions are at least partially formed from the following criteria:
Properties of at least one memory unit of the at least two memory units;
State of at least one memory unit of the at least two memory units;
Condition of the data to be stored; and
Requesting of at least one application to at least one memory unit.

11. The adhoc communications network memory administration unit as claimed in claim 8,
wherein the memory administration unit is contained in an adhoc communications device of the at least two adhoc communications devices.

12. An adhoc communications device, comprising:
at least one memory unit; and
an internal memory access control unit configured to control access to the at least one memory unit;
wherein the internal memory access control unit is configured to communicate with a memory administration unit using an adhoc communications protocol.

13. The adhoc communications device as claimed in claim 12,
wherein the internal memory access control unit is configured to communicate with an external memory administration unit using an adhoc communications protocol.

14. The adhoc communications device as claimed in claim 12,
configured to communicate according to a wireless adhoc communications protocol.

15. The adhoc communications device as claimed in claim 14,
configured to communicate according to a close range radio adhoc communications protocol.

16. The adhoc communications device as claimed in claim 15,
configured to communicate according to a Bluetooth adhoc communications protocol.

17. The adhoc communications device as claimed in claim 12,
wherein the internal memory access control unit is configured to select a memory unit from the at least one memory unit configured to store data to be stored, taking into account predefined peripheral conditions.

18. The adhoc communications device as claimed in claim 17,
wherein the predefined peripheral conditions are at least partially formed from the following criteria:
Properties of the at least one memory unit;
State of the at least one memory unit;
Condition of the data to be stored; and
Requesting of at least one application to at least one memory unit.

19. The adhoc communications device as claimed in claim 17,
wherein the internal memory access control unit is configured to determine the peripheral conditions.

20. An adhoc communications device, comprising:
at least one memory unit;
an internal memory access control unit configured to control access to the at least one memory unit;
wherein the internal memory access control unit is configured to operate as a memory administration unit for jointly administering the at least one memory unit and at least one memory unit of another adhoc communications device using an adhoc communications protocol.

21. The adhoc communications device as claimed in claim 20,
configured to communicate according to a wireless adhoc communications protocol.

22. The adhoc communications device as claimed in claim 21,
configured to communicate according to a close range radio adhoc communications protocol.

23. The adhoc communications device as claimed in claim 22,
configured to communicate according to a Bluetooth adhoc communications protocol.

24. The adhoc communications device as claimed in claim 20,
wherein the internal memory access control unit is configured to select the at least one memory unit of the adhoc communications device or the at least one memory unit of the other adhoc communications device for storing data to be stored,
taking into account the properties of the memory units.

25. An adhoc communications device, comprising:
at least one memory unit;
a memory administration unit which is configured to jointly administer the at least one memory unit and at least one memory unit of another adhoc communications device using as adhoc communications protocol.
